(19) United States
(12) Patent Application Publication
(10) Pub. No.: US 2024/0109499 A1
(43) Pub. Date: Apr. 4, 2024

(54) Systems With Movable Displays

(71) Applicant: Apple Inc., Cupertino, CA (US)

(72) Inventors: Kurt R Stiehl, Los Gatos, CA (US); Dominic E Dolci, Scotts Valley, CA (US); Stephen B Lynch, Portola Valley, CA (US)

(21) Appl. No.: 18/529,969

(22) Filed: Dec. 5, 2023

Related U.S. Application Data
(63) Continuation of application No. PCT/US22/30786, filed on May 24, 2022.
(60) Provisional application No. 63/210,900, filed on Jun. 15, 2021.

(51) Int. Cl. B60R 11/02

(52) U.S. Cl. CPC B60R 11/0235; B60R 2011/0085

(57) ABSTRACT

A vehicle may have a vehicle body and one or more displays. A display may be coupled to a roof portion of the vehicle body with a hinge or other attachment structure, may be mounted within a vehicle armrest, may be attached to a door, or may otherwise be mounted in an interior region of the vehicle body. The display may be a one-sided display, a two-sided display, a display with a touch sensitive edge portion formed from a strip-shaped pixel array extending along a peripheral display sidewall, a lenticular display or other display that is configured to display separate images to different respective vehicle occupant locations, or other suitable display. A positioner may rotate the display, slide the display, or otherwise move the display between a stowed position and one or more deployed position.

This application is a continuation of international patent application No. PCT/US22/30786, filed May 24, 2022, which claims priority to U.S. provisional patent application No. 63/210,900, filed Jun. 15, 2021, which are hereby incorporated by reference herein in their entireties.

### FIELD

This relates generally to systems such as vehicles, and, more particularly, vehicles that have displays.

### BACKGROUND

Automobiles and other vehicles have propulsion and steering systems. Displays are used to present visual information to vehicle occupants.

### SUMMARY

A vehicle may have a vehicle body and one or more displays. The vehicle may have a vehicle body with an interior region in which seating is located. A display may be coupled to a roof portion of a vehicle body with a hinge or other attachment structure, may be mounted within a vehicle armrest, may be attached to a dashboard, or may otherwise be mounted in the interior region.

The display may be a one-sided display or a two-sided display. A two-sided display may be viewed in opposing first and second directions by vehicle occupants in respective opposing front-facing and rear-facing seats.

A display may have a touch sensitive edge portion formed from a strip-shaped pixel array extending along a peripheral display sidewall. A vehicle occupant may supply touch input to the edge portion. In some configurations, the vehicle may contain a lenticular display or other display that is configured to display separate images to different respective vehicle occupant locations. A camera may monitor vehicle occupant locations to gather gestures or other user input from different vehicle occupants. The images displayed to each occupant can be adjusted based on user input from that occupant.

A positioner may rotate the display, slide the display, or otherwise move the display between a stowed position and one or more deployed position. The positioner may adjust the position of the display based on user input such as touch input to a touch sensitive edge portion of the display, based on environmental measurements, based on measurements on the operation of the vehicle (e.g., information on door opening and closing, vehicle movement, etc.), and/or other input.

### BRIEF DESCRIPTION OF THE DRAWINGS

FIG. 1 is a side view of an illustrative vehicle in accordance with an embodiment.

FIG. 2 is a side view of an illustrative interior region of a vehicle in accordance with an embodiment.

FIG. 3 is a top view of an illustrative vehicle with a display mounted to a portion of a vehicle body in accordance with an embodiment.

FIG. 4 is a side view of an illustrative movable display in accordance with an embodiment.

FIG. 5 is a perspective view of an illustrative display having a strip-shaped pixel array that forms a peripheral edge portion of the display in accordance with an embodiment.

FIG. 6 is a side view of an illustrative display that may be deployed into an interior vehicle region from a roof structure in a vehicle body in accordance with an embodiment.

FIG. 7 is a top view of an illustrative vehicle interior having seating and a display in accordance with an embodiment.

FIG. 8 is a perspective view of a vehicle structure such as an arm rest in an interior region of a vehicle body in accordance with an embodiment.

FIG. 9 is a perspective view of an interior portion of a vehicle having a stowable display in accordance with an embodiment.

FIG. 10 is a top view of an illustrative vehicle interior with a display and a sensor such as a camera for monitoring vehicle occupants in accordance with an embodiment.

FIG. 11 is a flow chart of illustrative operations associated with operating a vehicle in accordance with an embodiment.

### DETAILED DESCRIPTION

A system such as a vehicle or other system may have displays. Displays may be mounted on dashboards, armrests, headrests, doors, roofs, and/or other portions of a vehicle. In an illustrative configuration, a vehicle may have one or more displays that can move between stowed and deployed states. A display may, as an example, transition between a stowed position and a deployed position in response to input from a user or in response to conditions that are monitored by sensors in the vehicle.

In a stowed position, a display may lie flush with an interior surface of a vehicle. When moved from the stowed position to a deployed position, the display may protrude into an interior portion of the vehicle where the display is accessible to one or more users (vehicle occupants). As an example, a display may be attached to a vehicle using a hinge that allows the display to be folded up and out of the way for storage or to be folded down to allow the content on the display to be viewed by users.

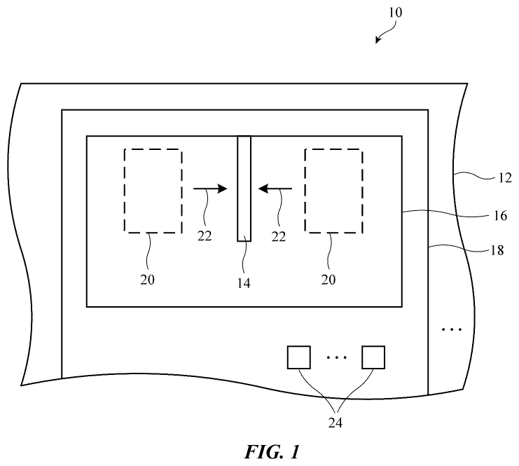

FIG. 1 is a side view of a portion of an illustrative vehicle. In the example of FIG. 1, vehicle 10 is the type of vehicle that may carry passengers (e.g., an automobile, truck, or other automotive vehicle). Configurations in which vehicle 10 is a robot (e.g., an autonomous robot) or other vehicle that does not carry human passengers may also be used. Vehicles such as automobiles may sometimes be described herein as an example.

Vehicle 10 may be manually driven (e.g., by a human driver), may be operated via remote control, and/or may be autonomously operated (e.g., by an autonomous driving system or other autonomous propulsion system). Vehicle 10 may include a body such as body 12. Body 12 may include vehicle structures such as body panels formed from metal and/or other materials, may include doors, a hood, a trunk, fenders, a chassis to which wheels are mounted, a roof, etc. Windows 16 may be formed in doors 18 (e.g., on the sides of vehicle body 12, on the roof of vehicle 10, and/or in other portions of vehicle 10). Windows 16, doors 18, and other portions of body 12 may separate the interior of vehicle 10 from the exterior environment that is surrounding vehicle 10.

Doors 18 may be opened and closed to allow people to enter and exit vehicle 10. Seats and other structures may be formed in the interior of vehicle body 12. When vehicle occupants (sometimes referred to as users) are resting on seats in the interior of body 12, the heads of the users, may be located in regions such as head boxes 20. This allows the users to view opposing sides of display 14 in directions 22 (e.g., in an arrangement in which display 14 is a two-sided display).

Display 14 may be a light-emitting diode display, a liquid crystal display, or other suitable display. One or more arrays of pixels may be used to form active display areas that display images. In an illustrative configuration, display 14 may have a shape and size that allows display 14 to be mounted on the roof of vehicle 10 (e.g., to an elongated roof member or other portion of vehicle body 12).

Display 14 may have first and second opposing sides. Display 14 may be a one-sided display in which a pixel array is formed on the first side and not on the second side or may be a two-sided display in which the first side of the display has a first pixel array for displaying images for a first user and a second side of the display has a second pixel array for displaying images for a second user. Display 14 may optionally also have a peripheral sidewall on which a strip-shaped pixel array forms an edge display area. Touch sensors (e.g., capacitive touch sensors formed from capacitive touch sensor electrodes may overlap the pixel array(s) of display 14 (e.g., display 14 may be a touch screen display). In some configurations, displays such as display 14 may be supported by armrests and/or other interior vehicle structures. The use of a mounting arrangement for display 14 that allows display 14 to hang from the roof of vehicle 10 as shown in FIG. 1 is illustrative.

Vehicle 10 may include components 24. Components 24 may include propulsion and steering systems (e.g., manually adjustable driving systems and/or autonomous driving systems having wheels coupled to body 12, steering controls, one or more motors for driving the wheels, etc.), and other vehicle systems. Components 24 may include control circuitry and input-output devices. Control circuitry in components 24 may be configured to run an autonomous driving application, a navigation application (e.g., an application for displaying maps on display 14), and software for controlling vehicle climate control devices, lighting, media playback, window movement, door operations, sensor operations, and/or other vehicle operations. The control circuitry may include processing circuitry and storage and may be configured to perform operations in vehicle 10 using hardware (e.g., dedicated hardware or circuitry), firmware and/or software. Software code for performing operations in vehicle 10 and other data is stored on non-transitory computer readable storage media (e.g., tangible computer readable storage media) in control circuitry 18. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid state drives), one or more removable flash drives or other removable media, or other storage. Software stored on the non-transitory computer readable storage media may be executed on the processing circuitry of components 24. The processing circuitry may include application-specific integrated circuits with processing circuitry, one or more microprocessors, a central processing unit (CPU) or other processing circuitry.

The input-output devices of components 24 may include displays such as display 14, sensors, buttons, light-emitting diodes and other light-emitting devices, haptic devices, speakers, and/or other devices for gathering environmental measurements, information on vehicle operations, and/or user input. The sensors in components 24 may include ambient light sensors, touch sensors, force sensors, proximity sensors, optical sensors such as cameras operating at visible, infrared, and/or ultraviolet wavelengths (e.g., fisheye cameras and/or other cameras), capacitive sensors, resistive sensors, ultrasonic sensors (e.g., ultrasonic distance sensors), microphones, three-dimensional and/or two-dimensional images sensors, radio-frequency sensors such as radar sensors, lidar (light detection and ranging) sensors, door open/close sensors, seat pressure sensors and other vehicle occupant sensors, window sensors, position sensors for monitoring location, orientation, and movement, speedometers, satellite positioning system sensors, and/or other sensors. Output devices in components 24 may be used to provide vehicle occupants and others with haptic output, audio output, visual output (e.g., displayed content, light, etc.), and/or other suitable output.

During operation, the control circuitry of components 24 may gather information from sensors and/or other input-output devices such as lidar data, camera data (images), radar data, and/or other sensor data. Cameras, touch sensors, physical controls, and other input devices may be used to gather user input. Using wireless communications with vehicle 10, remote data sources may provide the control circuitry of components 24 with database information (e.g., maps, still and/or moving images, audio, etc.). Media such as images and audio recordings may also be stored locally in storage in vehicle 10. Control circuitry in components 24 may use sensor data, user input, media from databases, and other data in presenting interactive maps and other features to users and in presenting video and other media to users. Interactive maps associated with a navigation application and interactive content associated with other applications may be displayed on display 14. A user may interact with this interactive content by supplying touch input to a touch sensor in display 14 and/or by providing user input with other input devices. If desired, the control circuitry of vehicle 10 may use sensor data, user input, information from remote databases, and/or other information in providing a driver with driver assistance information (e.g., information on nearby obstacles on a roadway and/or other environment surrounding vehicle 10) and/or in autonomously driving vehicle 10.

During the playback of video and other media and during presentation of interactive applications for a user, vehicle 10 (e.g., the control circuitry of components 24) may use displays such as display 14 to present visual content (still and/or moving images). Display 14 is not always operating, so it may be desirable to provide motors or other actuators (e.g., rotational positioners, robotic arms, linear actuators, and/or other positioners) that can move display 14 between different positions. These positions may include, for example, a stowed position in which display 14 lies flush with an interior surface of vehicle body 12, in which display 14 is hidden from view behind a movable window, in which display 14 is received within an armrest or other interior vehicle structure, or in which display 14 is otherwise placed in a storage location. The different position(s) to which display 14 may be moved may also include one or more deployed positions in which the images on the display are viewable by one or more users. In the example of FIG. 1, display 14 has at least first and second active areas formed by first and second respective pixel arrays on first and second opposing sides of display 14. This allows first and second users that are facing each other (e.g., users with heads located in respective head boxes 20) to view first and second corresponding images on the first and second sides of display 14, respectively.

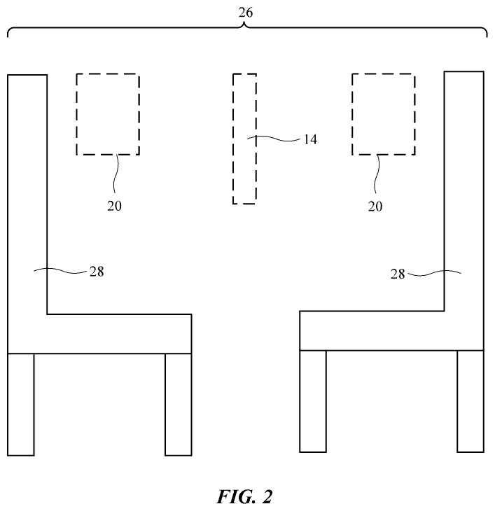

If desired, vehicle 10 may have an interior region such as interior region 26 of FIG. 2 that contains seating 28. Seating 28 may include bucket seats, bench seats, and/or other seats on which vehicle occupants may sit. In the example of FIG. 1, seating 28 includes first and second seats that face each other, allowing users with heads in head boxes 20 to view opposing sides of display 14. Seating 28 may be oriented so that one or more users face forward as vehicle 10 is driven forward and so that one or more users face rearward as vehicle 10 is driven forward. Arrangements in which the seats of vehicle 10 face to the side, in which all seats face forward, in which seats may be rotated between forward and rearward orientations and/or other orientations, and/or in which the seats of vehicle 10 have other configurations may also be used. The example of FIG. 2 in which interior 26 contains one or more rearward-facing bucket seats and/or bench seats and one or more opposing forward-facing bucket seats and/or bench seats is illustrative.

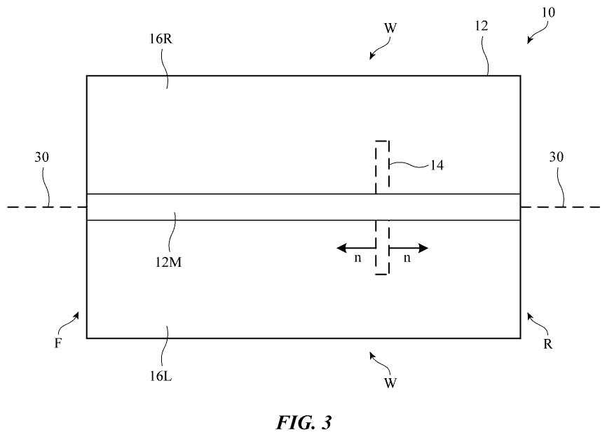

To allow display 14 to deploy into a vertical orientation between rearward-facing users and forward-facing users of the type shown in FIG. 2, display 14 may be mounted on a roof portion of vehicle 10 (e.g., an elongated roof member formed from metal, polymer, and/or other materials and/or other roof structure associated with body 12). Consider, as an example, the illustrative configuration for vehicle body 12 that is shown in FIG. 3. As shown in FIG. 3, vehicle body 12 may include an elongated roof member 12M that runs parallel to the length of vehicle 10 between front F and rear R of vehicle 10. Member 12M, which may sometimes be referred to as a longitudinal vehicle body member, vehicle roof member, or vehicle roof spline structure, may form a roof structure that supports a left window 16L and a right window 16R on the roof of vehicle 10. One or more displays such as display 14 may be mounted to roof structures in vehicle body 12 such as roof member 12M. As shown in FIG. 3, for example, display 14 may be mounted so that surface normals n of the front and rear sides of display 14 run parallel to member 12M and longitudinal axis 30 of vehicle 10 (e.g., when display 14 is deployed for use by the occupants of vehicle 10). Arrangements in which display 14 is mounted to vehicle body 12 with surface normals n facing to the left and right sides W of body 12 may also be used, if desired.

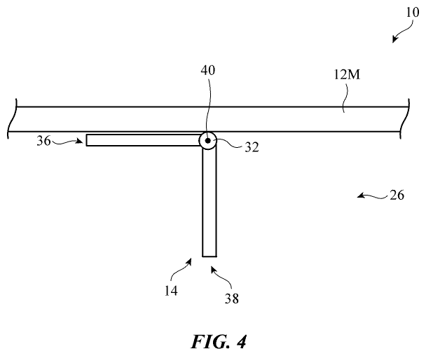

A side view of display 14 and vehicle 10 of FIG. 3 is shown in FIG. 4. As shown in FIG. 4, display 14 may be coupled to roof member 12M using hinge 32. A positioner such as a rotating positioner may be embedded in hinge 32 and/or may otherwise be coupled to display 14, so that the control circuitry of vehicle 10 may move display 14 about hinge axis 40. If, for example, it is desired to store display 14 out of the way (e.g., when the main surfaces of display 14 are not in use), display 14 may be rotated about axis 34 until display 14 rests against the roof of vehicle 10 (see, e.g., stowed position 36). When it is desired to deploy display 14 so that users may view the opposing sides of display 14 in directions 22, display 14 may be rotated about axis 34 to deployed position 38. Display 14 may, in some embodiments, be configured to serve as a sun visor in addition to serving as a display (e.g., when display 14 is mounted adjacent to a front window above a dashboard or when display 14 is otherwise adjacent to a window in vehicle 10). Light may be emitted by display 14, display 14 may also be configured to serve as an interior light for vehicle 10 (e.g., display 14 may be operated in a lighting mode in which few or no discernable patterns are displayed on the pixels of display 14 so that light output is uniform and has a desired color for serving as interior illumination for vehicle 10).

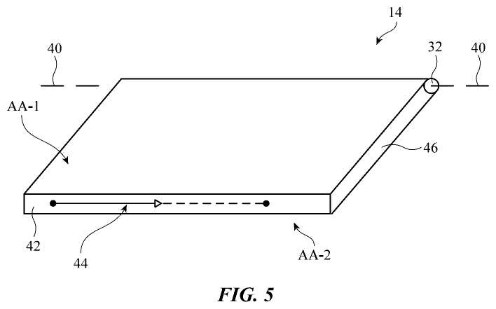

FIG. 5 is a perspective view of an illustrative display. As shown in FIG. 5, display 14 may have a first pixel array on a first side of display 14 (see, e.g., side AA-1) and a second pixel array on an opposing second side of display 14 (see, e.g., side AA-2). These two opposing sides of display 14 may have planar surfaces with rectangular outlines or other suitable shapes. During operation, images (which may be the same or different from each other) may be displayed on the first and second sides of display 14 (e.g., for viewing by two vehicle occupants who are facing each other). If desired, display 14 may have a strip-shaped array of pixels that form a peripheral edge display. As shown in FIG. 5, for example, display 14 may have a peripheral sidewall that is covered with display 42. Display 42 may be formed from an elongated strip of pixels (e.g., an elongated pixel array) that covers at least a portion of the edge of display 14. Display 42, which may sometimes be referred to as an edge display, peripheral sidewall display, peripheral edge display, edge display portion, etc., may be used to display icons and other visual content (see, e.g., illustrative image 44). Image 44 may, as an example, contain graphics such as a vehicle icon on a trip progress line representing the progress of vehicle 10 along a route between a starting point and an ending point and/or may contain other content. Touch sensors may be incorporated on the edge portion of display 14 (e.g., on edge display 42 of FIG. 5 and on sides AA-1 and AA-2 so that a user may supply touch input for controlling interactive visual content on display 14. Touch input provided to edge display 42 and/or other surfaces of display 14 may also be used to direct the control circuitry of vehicle 10 to move display 14 to a deployed state from a stowed state.

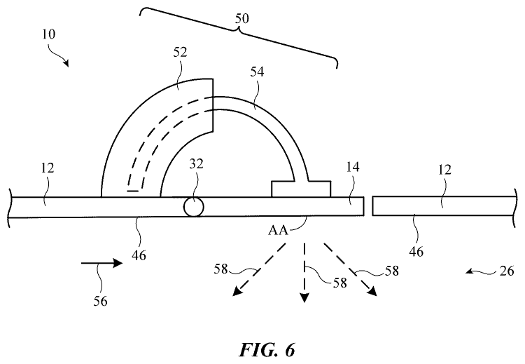

FIG. 6 is a cross-sectional side view of display 14 in an illustrative configuration in which display 14 can be moved between a stowed position in which side AA is flush with interior surface 46 of the roof of body 12 and a deployed position (see, e.g., position 48) in which sides AA is deployed so that images on side AA may be viewed in direction 56. Positioner 50 may have a motor or other actuator such as actuator 52 and a movable support member such as member 54 that is moved into and out of actuator 52 in response to control signals from the control circuitry of components 24. When display 14 is not being used to display images, display 14 operate in an interior lighting mode in which display 14 serves as a light for the interior of vehicle 10. As shown in FIG. 6, for example, rather than displaying text, graphics, video, and other images on the pixel array of side AA (as when display 14 is deployed for normal operation), the pixels of side AA may be uniformly lit to produce white light, yellow light, and/or other light that serves as interior illumination 58 for objects in interior region 26 when display 14 is stowed. Side AA may, as an example, contain a uniform block of white pixels when display 14 is operated in the interior illumination mode rather than its normal display mode (in which video and other images are displayed). The brightness and/or color of the block of pixels used to produce interior illumination 58 may be adjusted in response to user input such as touch sensor input on an edge touch display portion of display 14, voice input, and/or other user input and/or in response to other sensor data such as measured outdoor lighting conditions. For example, a user may adjust a touch-screen slider on edge display portion 42 when display 14 is in position 36 of FIG. 4, a user may supply a voice command such as “turn on lights”, or a user may press a button that directs display 14 to enter its interior lighting mode of operation.

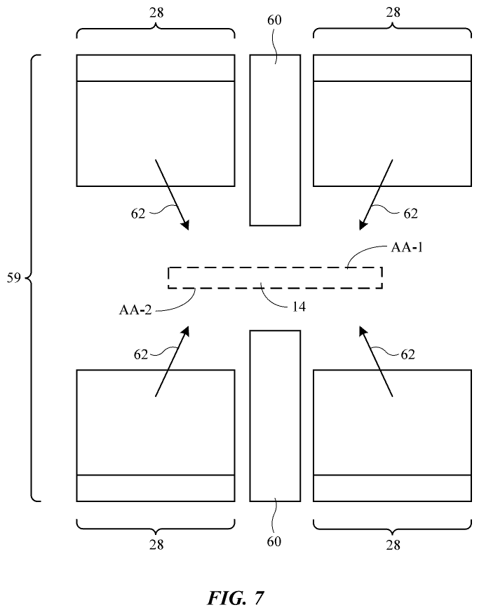

FIG. 7 is a top view of an interior region of vehicle 10. As shown in FIG. 7, seating 28 (e.g., forward-facing seats and opposing rearward-facing seats) may be formed in interior region 59 of vehicle body 12. Users in seating 28 may view display 14 in directions 62. When forward-facing and rearward-facing users of vehicle 10 are seated facing each other in seating 28, these users may respectively view sides AA-1 and AA-2 of display 14 (e.g., forward-facing users may view one side of display 14 and rearward-facing users may face the other side of display 14).

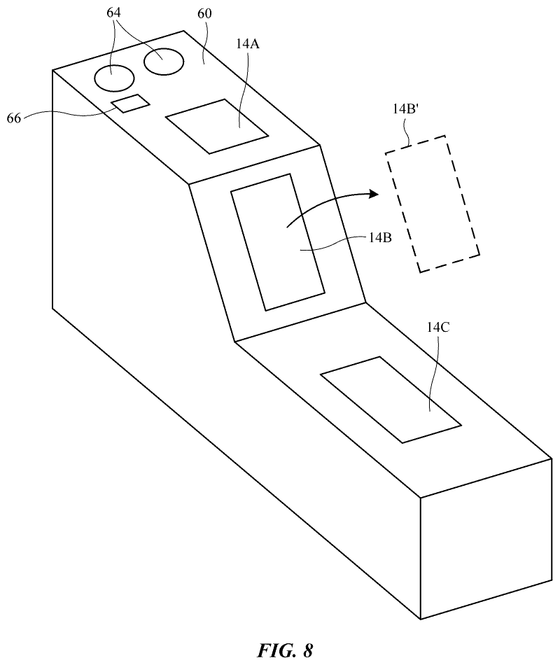

Armrests 60 may be formed between left and right forward-facing seats on the left and right of vehicle 10, respectively, and between left and right rearward-facing seats on the left and right of vehicle 10, respectively. If desired, one or more displays may be mounted to armrests 60. FIG. 8 shows how displays such as illustrative displays 14A, 14B, and 14C (e.g., single-sided touch screen displays) may be supported by armrest 60. Cup holders 64, storage compartments such as bin 66, and other structures may be formed in armrest 60, if desired. Displays 14A, 14B, and/or 14C may be fixed to armrest 60 or one or more of these displays may be removable from armrest 60. As shown in FIG. 8, for example, display 14B may normally reside in a recess in armrest 60. When a user desires to hold display 14B in the user's hand, the user may remove display 14B from armrest 60 (see, e.g., removed display location 14B′).

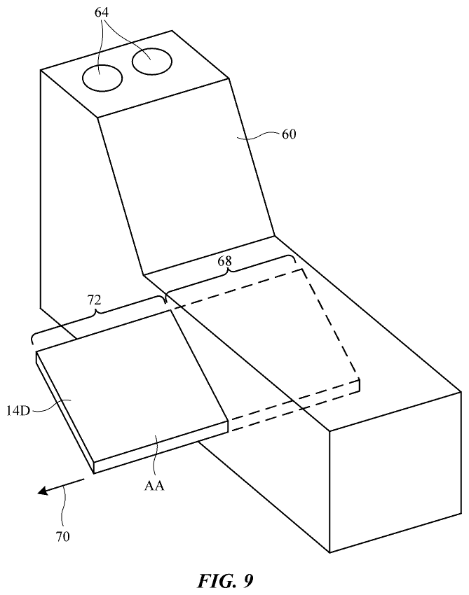

Another illustrative configuration for armrest 60 is shown in FIG. 9. In the example of FIG. 9, display 14D is movable between a stowed position in which display 14D is stored in slot 68 inside of armrest 60 and a deployed position in which display 14D is pulled out of the slot in direction 70. In deployed position 72, display 14D extends outwardly from armrest 60 so that images on side AA of display 14D may be viewed by a user sitting in a nearby seat. If desired, display 14D may be selectively deployed from the right and left of armrest 60 so that users seated to the left and right of the armrest can access the display. Displays may also be mounted in doors (e.g., door handles) and/or other vehicle structures accessible from the interior of vehicle 10.

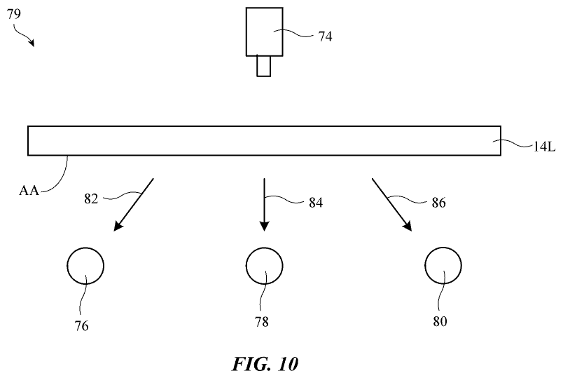

One or more cameras and/or other sensors may be used to monitor users in the interior of vehicle 10. As shown in FIG. 10, for example, interior 79 may contain one or more cameras such as camera 74 that monitor users 76, 78, and 80. Camera 74 may be a two-dimensional camera or a three-dimensional camera operating at ultraviolet, visible, and/or infrared wavelengths. Camera 74 may be used to measure hand gestures and other user input related to body motions, may be used to track the direction of gaze of the eyes of users 76, 78, and 80, may be used to determine the orientations of the heads of users 76, 78, and 80, may be used as a vehicle occupant sensor that detects when users are present in the interior of vehicle 10, and may otherwise be used to monitor user presence and behavior.

Display 14L of FIG. 10 may be a lenticular display or other display configured to display user-specific content to each user individually. By determining which users are viewing display 14L, by determining the position of each user, and/or by monitoring the motions of each user's hands, the control circuitry of vehicle 10 can control display 14L to display user-specific content for each user and can gather user input from each user individually. As an example, display 14L may display a first image in direction 82, a second image in direction 84, and a third image in direction 86. The first image may be viewable by user 76 while remaining invisible to users 78 and 80. The second image may be viewable only by user 78. The third image may be viewable by user 80 while not being visible to users 76 and 78. Camera 74 may gather hand gestures or other user input from each individual user. With this type of arrangement, vehicle 10 may provide customized user-specific content to each occupant in vehicle 10. Each user may interact with their customized interactive image on display 14L using hand gesture input or other user-specific input. As with the other displays in vehicle 10, display 14L of FIG. 10 may be mounted to inside of the roof of vehicle 10, may be stowed in an arm rest, may be mounted in a dashboard, door, or other interior structure, and/or may otherwise be supported in the interior of vehicle 10 for viewing by the occupants of vehicle 10.

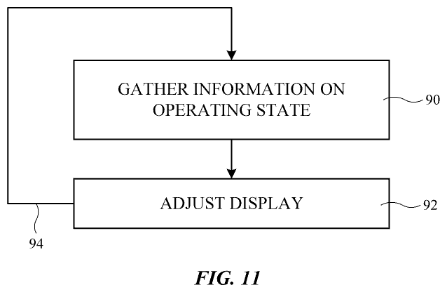

FIG. 11 is a flow chart of illustrative operations involved in using vehicle 10. During the operations of block 90, sensors in components 24 may be used in making measurements on the operation of vehicle 10, may be used in gathering sensor data from the interior of vehicle 10, may be used in gathering information on the exterior environment surrounding vehicle 10, and may be used in gathering user input. Examples of information on the operation of vehicle 10 that may be gathered include information on the state (open or closed) of doors 18 from door sensors, information on the speed, direction of motion, orientation, and other attributes of the steering and propulsion system of vehicle 10 (e.g., whether vehicle 10 is parked, whether vehicle 10 is being driven autonomously, the speed at which vehicle 10 is moving, whether vehicle 10 is parked, etc.), etc. If desired, vehicle position information (e.g., geographic location, motion, orientation, etc.) may be gathered using an inertial measurement unit in components 24, using a Global Positioning System in components 24, and/or using other position sensors). Geographical vehicle location information (e.g., when compared to a map database or other information source) may indicate whether vehicle 10 is in a parking lot, is on a highway, is near to particular services or roadway features, etc. Examples of information that may be gathered on the environment in which vehicle 10 is operating include temperature information, precipitation information, road conditions, and other weather information, traffic conditions, ambient light levels, the locations of nearby pedestrians, road sign text, etc. Examples of interior information that may be gathered by the sensors of vehicle 10 include user input such as button press input, knob rotation input, touch sensor input (e.g., touch gestures, touch screen menu selections, etc.), force sensor input, air gesture (e.g., hand gesture) input from a three-dimensional and/or two-dimensional camera system, voice input gathered with a microphone, direction-of-gaze information, head position and orientation, other body movements, etc. The sensors of vehicle 10 may include door sensors that can sense door opening and closing events, seat pressure sensors that can detect which seats are occupied by users, cameras and other sensors that detect human body temperature, body shapes, and/or other user characteristics that allow these sensors to serve as vehicle occupant sensors, and/or other sensors that monitor for the presence and activities of users.

During the operations of block 92, displays such as display 14 may be moved, media (still and/or moving images) may be presented on displays 14 (and accompanying audio played through speakers), and/or other aspects of the operation of display 14 and/or other output devices in vehicle 10 may be adjusted based on the information gathered during block 90. Consider, as an example, a scenario in which display 14 has been rotated or otherwise moved to a position resting against the roof of vehicle 10 or a position within a recess in the roof of vehicle body 12 when vehicle 10 was parked. Vehicle 10 (e.g., control circuitry in vehicle 10) may use a user presence sensor to detect the user when the user enters vehicle 10. Vehicle 10 may, for example, use a door sensor to detect that a user has opened a door, may use a seat pressure sensor to detect arrival of a seated user, may use a camera to detect the presence of a user, or may use other sensors to determine when a user has entered into the interior of vehicle 10. Information on which seats are being occupied by users may be obtained from seat presence sensor circuitry, one or more cameras, or other sensors, if desired. In response to determining that one or more users have entered vehicle 10 or have supplied user input, in response to measurements on the operating characteristics of vehicle 10 such as measurements on vehicle speed, parking status, autonomous driving status, etc., in response to the state of the environment surrounding vehicle 10, and/or in response to the state of the interior of vehicle 10, vehicle 10 (e.g., control circuitry in vehicle 10) may use a positioner associated with display 14 to move display 14. As an example, vehicle 10 may use the positioner to rotate display 14 back out of the recess in the roof of vehicle body 12 and/or may otherwise deploy display 14 for use by one or more users in vehicle 10. If desired, a user may supply touch input to a touch sensitive edge display on display 14 while display 14 is stowed that directs vehicle 10 to use the positioner to rotate display 14 out of its stowed position in the roof of body 12 to a deployed position of the type shown in FIG. 4. Voice commands, hand gestures, button press input, and/or other user input may also be used as commands to deploy display 14. These forms of user input (touch input, voice commands, button press input, hand gesture input, etc.) may also be used to interact with mapping applications, navigation applications, applications that control vehicle climate, media playback applications, and/or other interactive content (interactive images) displayed on display 14. Additionally, this user input may be used to adjust the deployed position of display 14 and/or may be used as commands to stow display 14. If desired, display 14 may be deployed by using a positioner to slide display 14 out of a storage slot in armrest 60, as described in connection with FIG. 9.

In addition to or instead of deploying display 14 based on vehicle occupant detection or user input, vehicle 10 may deploy (and stow) display 14 in response to detecting that vehicle 10 is moving (e.g., in response to detection of a transition from a parked state to a driving state), may be deployed in response to detection of engagement of the autonomous driving mode of vehicle 10, or may be deployed in response to satisfaction of other criteria (e.g., one or more criteria associated with one or more of the sensor measurements of block 90).

Content may be displayed on one or both sides of a two-sided display. For example, if seat sensors, one or more cameras, or other sensor circuitry determines that only forward-facing users are in the interior of vehicle 10, only a rear-facing side of display 14 may be activated and used to display visual content. If, however, seat sensors, one or more cameras, or other sensor circuitry determines that both rearward-facing and forward-facing users are present, both sides of display 14 may be activated and used in displaying content. In some scenarios, display 14 may be a lenticular display as shown in FIG. 10 (or may be a parallax barrier display or any other display that can display different images simultaneously to different respective locations). In this type of arrangement, vehicle 10 may display user-specific content to each detected user by adjusting the content that is output in each user's direction with the lenticular display or other display. In general, any type of media may be presented to the users of vehicle 10 (e.g., audio, still images, moving images, haptic output, etc.). In an illustrative configuration, moving images and accompanying audio (e.g., streaming video for a movie) may be presented on display 14, interactive application content (e.g., a navigation application, a shopping application, an internet browser, and/or other application output presented using interactive images) may be presented on display 14, interactive images for vehicle control functions (e.g., climate adjustment menus, navigation and driving menus, etc.) may be presented on display 14, and/or other content may be displayed using display 14.

During the operations of block 92, display 14 may be moved to one or more positions (stowed positions and/or deployed positions) and/or other adjustments may be made (e.g., ensure that content on display 14 is viewable by vehicle occupants, in response to user commands, etc.). The data gathering operations of block 90 may, if desired, continue to be performed during the operations of block 92. This allows display 14 to be automatically stowed and/or otherwise adjusted (e.g., in response to detecting that users have exited vehicle 10 by monitoring a door sensor, seat pressure sensor, vehicle occupant monitoring camera, etc.). As an example, display 14 may be moved into a recess in the roof of body 12 in response to detection that vehicle 10 has parked or that manual driving operations are being performed instead of autonomous driving operation, in response to detecting that vehicle 10 has exited the highway, in response to receiving a command from a user, in response to detecting that a door has opened, in response to detection of the absence of seat pressure in a seat formerly occupied by a user, etc.

As shown by line 94, the operations of FIG. 11 may be performed continuously during operation of vehicle 10.

In accordance with an embodiment, a vehicle is provided that includes a vehicle body having face-to-face seating; a two-sided display configured to be viewed from the face-to-face seating in opposing first and second directions; a sensor configured to gather information; and a positioner configured to move the two-sided display in response to the gathered information.

In accordance with another embodiment, the vehicle body has an elongated roof member and a hinge that couples the two-sided display to the elongated roof member and the positioner is configured to rotate the two-sided display about the hinge.

In accordance with another embodiment, the sensor includes a sensor selected from the group consisting of: a door sensor and a seat pressure sensor.

In accordance with another embodiment, the sensor includes a camera in an interior region of the vehicle body.

In accordance with another embodiment, the vehicle body has a roof with a recess configured to receive the two-sided display.

In accordance with another embodiment, the positioner is configured to rotate the display between a stowed position in which one side of the two-sided display is flush with an interior surface of the roof and a deployed position in which first and second opposing sides of the two-sided display are viewable from respective first and second head boxes associated with the face-to-face seating.

In accordance with another embodiment, the two-sided display is configured to rotate about a hinge coupled to the vehicle body.

In accordance with another embodiment, the face-to-face seating includes a forward-facing seat and an opposing rearward-facing seat and the two-sided display is coupled to the vehicle body between the forward-facing seat and the opposing rearward-facing seat.

In accordance with another embodiment, the two-sided display has a first pixel array on a first side of the display, has a second pixel array on an opposing second side of the display, and has a touch sensitive edge display portion extends along a peripheral sidewall of the display.

In accordance with another embodiment, the gathered information includes information on vehicle operating status and the positioner is configured to move the two-sided display in response to the gathered information on vehicle operating status.

In accordance with an embodiment, a vehicle is provided that includes a vehicle body having a roof structure; a display coupled to the roof structure, the display has an edge display portion that extends along a peripheral sidewall of the display; and a positioner configured to move the display relative to the roof structure.

In accordance with another embodiment, the roof structure includes windows separated by an elongated vehicle roof member that extends between a front portion of the vehicle body and a rear portion of the body and the vehicle includes a hinge that couples the display to the elongated vehicle roof member.

In accordance with another embodiment, the vehicle includes a hinge that couples the display to the roof structure, the positioner is configured to move the display about the hinge in response to touch input to the edge display portion.

In accordance with another embodiment, the vehicle includes a sensor configured to gather information on vehicle movement and the positioner is configured to move the display between a stowed position and a deployed position based on the gathered information.

In accordance with another embodiment, the roof structure has a recess and the positioner includes a movable member configured to move the display between a first position in which the display is received in the recess and a second position in which the display is not in the recess.

In accordance with another embodiment, the vehicle includes a camera, the positioner is configured to move the display in response to information gathered with the camera.

In accordance with another embodiment, the display is configured to display a first image to a first vehicle occupant location without displaying the first image to a second vehicle occupant location and is configured to simultaneously display a second image to the second vehicle occupant location without displaying the second image to the first vehicle occupant location.

In accordance with another embodiment, the display is operable in a first mode in which the display presents video and is operable in a second mode in which the display serves as a light configured to produce interior illumination for an interior region of the vehicle body.

In accordance with an embodiment, a vehicle is provided that includes a vehicle body having an interior region; first and second seats in the interior region; an armrest between the first and second seats; a display; and a positioner configured to move the display from inside of the armrest to outside of the armrest.

In accordance with another embodiment, the vehicle includes a sensor and the positioner is configured to move the display in response to information gathered using the sensor.

In accordance with another embodiment, the sensor includes a microphone and the positioner is configured to move the display in response to a voice command received with the microphone.

In accordance with another embodiment, the display is configured to display a first image to a first vehicle occupant location on the first seat without displaying the first image to a second vehicle occupant location on the second seat and is configured to simultaneously display a second image to the second vehicle occupant location without displaying the second image to the first vehicle occupant location.

In accordance with another embodiment, the vehicle includes a camera configured to: gather first user input from the first vehicle occupant location and adjust the first image based on the first user input; and gather second user input from the second vehicle occupant location and adjust the second image based on the second user input.

The foregoing is merely illustrative and various modifications can be made to the described embodiments. The foregoing embodiments may be implemented individually or in any combination.

What is claimed is:

1. A vehicle, comprising:
a vehicle body having face-to-face seating;
a two-sided display configured to be viewed from the face-to-face seating in opposing first and second directions;
a sensor configured to gather information; and
a positioner configured to move the two-sided display in response to the gathered information.

2. The vehicle defined in claim 1 wherein the vehicle body has an elongated roof member and a hinge that couples the two-sided display to the elongated roof member and wherein the positioner is configured to rotate the two-sided display about the hinge.

3. The vehicle defined in claim 1 wherein the sensor comprises a sensor selected from the group consisting of: a door sensor and a seat pressure sensor.

4. The vehicle defined in claim 1 wherein the sensor comprises a camera in an interior region of the vehicle body.

5. The vehicle defined in claim 1 wherein the vehicle body has a roof with a recess configured to receive the two-sided display.

6. The vehicle defined in claim 5 wherein the positioner is configured to rotate the display between a stowed position in which one side of the two-sided display is flush with an interior surface of the roof and a deployed position in which first and second opposing sides of the two-sided display are viewable from respective first and second head boxes associated with the face-to-face seating.

7. The vehicle defined in claim 1 wherein the two-sided display is configured to rotate about a hinge coupled to the vehicle body.

8. The vehicle defined in claim 7 wherein the face-to-face seating comprise a forward-facing seat and an opposing rearward-facing seat and wherein the two-sided display is coupled to the vehicle body between the forward-facing seat and the opposing rearward-facing seat.

9. The vehicle defined in claim 1 wherein the two-sided display has a first pixel array on a first side of the display, has a second pixel array on an opposing second side of the display, and has a touch sensitive edge display portion extends along a peripheral sidewall of the display.

10. The vehicle defined in claim 1 wherein the gathered information comprises information on vehicle operating status and wherein the positioner is configured to move the two-sided display in response to the gathered information on vehicle operating status.

11. A vehicle, comprising:
a vehicle body having a roof structure;
a display coupled to the roof structure, wherein the display has an edge display portion that extends along a peripheral sidewall of the display; and
a positioner configured to move the display relative to the roof structure.

12. The vehicle defined in claim 11 wherein the roof structure comprises windows separated by an elongated vehicle roof member that extends between a front portion of the vehicle body and a rear portion of the body and wherein the vehicle further comprises a hinge that couples the display to the elongated vehicle roof member.

13. The vehicle defined in claim 11 further comprising a hinge that couples the display to the roof structure, wherein the positioner is configured to move the display about the hinge in response to touch input to the edge display portion.

14. The vehicle defined in claim 11 further comprising a sensor configured to gather information on vehicle movement and wherein the positioner is configured to move the display between a stowed position and a deployed position based on the gathered information.

15. The vehicle defined in claim 11 wherein the roof structure has a recess and wherein the positioner comprises a movable member configured to move the display between a first position in which the display is received in the recess and a second position in which the display is not in the recess.

16. The vehicle defined in claim 11 further comprising a camera, wherein the positioner is configured to move the display in response to information gathered with the camera.

17. The vehicle defined in claim 11 wherein the display is configured to display a first image to a first vehicle occupant location without displaying the first image to a second vehicle occupant location and is configured to simultaneously display a second image to the second vehicle occupant location without displaying the second image to the first vehicle occupant location.

18. The vehicle defined in claim 11 wherein the display is operable in a first mode in which the display presents video and is operable in a second mode in which the display serves as a light configured to produce interior illumination for an interior region of the vehicle body.

19. A vehicle, comprising:
a vehicle body having an interior region;
first and second seats in the interior region;
an armrest between the first and second seats;
a display; and
a positioner configured to move the display from inside of the armrest to outside of the armrest.

20. The vehicle defined in claim 19 wherein the vehicle comprises a sensor and wherein the positioner is configured to move the display in response to information gathered using the sensor.

21. The vehicle defined in claim 19 wherein the sensor comprises a microphone and wherein the positioner is configured to move the display in response to a voice command received with the microphone.

22. The vehicle defined in claim 19 wherein the display is configured to display a first image to a first vehicle occupant location on the first seat without displaying the first image to a second vehicle occupant location on the second seat and is configured to simultaneously display a second image to the second vehicle occupant location without displaying the second image to the first vehicle occupant location.

23. The vehicle defined in claim 22 further comprising a camera configured to:
gather first user input from the first vehicle occupant location and adjust the first image based on the first user input; and
gather second user input from the second vehicle occupant location and adjust the second image based on the second user input.
